(19) United States
(12) Patent Application Publication
(10) Pub. No.: US 2014/0114689 A1
(43) Pub. Date: Apr. 24, 2014

(54) Systems for Insuring Service Providers

(71) Applicant: Moose Loop Holdings, LLC, Salt Lake City, UT (US)

(72) Inventors: Ken R. Davis, Salt Lake City, UT (US); Fraser M. Smith, Salt Lake City, UT (US); Nathaniel G. Jensen, Amherst, NH (US)

(73) Assignee: Moose Loop Holdings, LLC, Salt Lake City, UT (US)

(21) Appl. No.: 13/840,670

(22) Filed: Mar. 15, 2013

Related U.S. Application Data
(60) Provisional application No. 61/703,941, filed on Sep. 21, 2012.

(51) Int. Cl. G06Q 40/08

(52) U.S. Cl. CPC G06Q 40/08
USPC 705/4

(57) ABSTRACT

A method for providing insurance for tasks comprises identifying a task definition for a task to be performed for a customer. The task has task details associated therewith. A task value is set for the task based on the task details, using a processor. A service provider is assigned to perform the task at the task value, using the processor. A determination is made as to whether the service provider has adequate insurance to cover one or more insurable risks associated with performance of the task. A task insurance rider is requested to be applied to the task in the event the service provider does not have adequate insurance to cover the one or more insurable risks associated with performance of the task.

### PRIORITY CLAIM

Priority is claimed to U.S. Provisional Patent Application Ser. No. 61/703,941, filed Sep. 21, 2012, which is hereby incorporated herein by reference in its entirety.

### BACKGROUND

Many consumers rely on service providers for tasks such as yard care, house cleaning, construction work, and the like. While such service providers exist in abundance, many consumers have little reliable information available to them when selecting such a service provider. Many consumers are primarily interested in the details relating to the service or task that they wish to have performed. Oftentimes, they are not overly concerned with which service provider delivers such services, so long as the quality and cost of the service is within the consumer's expectations. In the past, however, consumers have generally had to evaluate the individual service provider they are considering for a job, as evaluating that service provider was the primary way to obtain a reasonable prediction of the quality and cost that might be achieved.

Also, most consumers would like to select a service provider that is reliable and that provides quality services. However, for liability purposes, it is important that the service provider carries insurance to shield the consumer from a variety of liabilities associated in some way with completion of the task. Many consumers are not sufficiently aware of this risk; and those that are often cannot obtain reliable information relating to whether or not the service provider carries insurance appropriate to cover liabilities, or particularly relating to the quality or adequacy of coverage of any such insurance.

Further, while service providers are likely aware that they should carry general liability insurance, along with other various types of insurance, many do not, or only carry limited insurance that is not really adequate to cover their risk profiles. Many service providers either feel that they cannot afford such coverage, or they feel overwhelmed at the seeming complexity involved in obtaining such coverage. Some service providers, of course, simply choose not to carry insurance at all.

Moreover, while insurance providers are certainly aware of the potential market for providing coverage to service providers, many insurance providers have struggled with capitalizing upon this large pool of potential customers.

### BRIEF DESCRIPTION OF THE DRAWINGS

FIG. 1 is a block diagram illustrating an example of a system for providing services, customer and task management, and insuring capability;

FIG. 2 is a flowchart illustrating of an example method by which a managing entity can obtain insurance coverage for tasks to be performed by service providers;

FIG. 3 is a flowchart illustrating an example method of providing insurance coverage of tasks to be performed by service providers;

FIG. 4 is block diagram illustrating an example of a computing device that may be used in insuring service providers.

FIG. 5 is a flowchart illustrating and example of a method of providing insurance for a service provider.

### DETAILED DESCRIPTION

Reference will now be made to the exemplary examples illustrated in the drawings, and specific language will be used herein to describe the same. It will nevertheless be understood that no limitation of the scope of the technology is thereby intended. Alterations and further modifications of the features illustrated herein, and additional applications of the examples as illustrated herein, which would occur to one skilled in the relevant art and having possession of this disclosure, are to be considered within the scope of the description.

The present technology provides systems and methods that allow an uninsured and/or an underinsured service provider to perform services for customers who wish to have insurance in place to cover liability associated with a task performed by the service provider. The system allows customers to order services or tasks from service providers that they may know little or nothing about, and yet be assured that one or more insurance policies or riders are in place to cover the task being ordered. The types of insurance that can be provided under the present system can vary, but can generally include coverage including, but not limited to: general liability insurance; workers' compensation insurance; occupational accident insurance; surety or performance bonding; and other types of insurance often carried by service providers (e.g., commercial vehicle insurance, etc.). While some of these types of insurance do not directly impact the customer ordering the task or service, they all have an impact on the overall commercial framework under which such services are provided, and they give customers peace of mind that service providers and their employees have adequate insurance to cover exigencies that may occur in the delivery of their service.

In one embodiment, the system allows customers to place orders for a commoditized service, independent of the contractor (e.g., service provider) who will perform or provide the service, and independent of whether the service provider has insurance. The system also allows service providers to join the network and have customers provided to them by the system. In one aspect, each service provider, upon joining, asserts whether or not he or she has worker's compensation insurance, and/or general liability insurance, and at what coverage level. If he or she does not have insurance, the system can automatically assess a daily insurance charge or a “per task insurance rider” each time the contractor performs work for a customer or some other equivalent arrangement whereby the service provider pays for their coverage based on days worked or tasks performed. In the case of the fee for a per task rider, this can generally be deducted from the revenues paid to the service provider for completing the task. Daily fees can similarly be prorated and charged to revenues from individual tasks performed during that day. If the service provider does carry insurance, the insurance can be validated by the same insurance company that is providing the riders (or by another party). If the insurance is found to be adequate, the service provider is not charged for the extra “per task insurance rider” for each task performed or daily task fee proration, and instead is paid the “normal” fee for completing the task.

Thus, it is contemplated that the present system will prove advantageous for customers in need of services, service providers looking for customers, and insurance providers desirous of insuring service providers (or insuring the tasks performed by service providers). One exemplary framework under which tasks, customers and service providers can be evaluated for purposes of applying insurance to tasks or service providers is outlined as follows:

A technology is provided for efficiently providing access to services via a networked computer system. More accurate and efficient access to services may commoditize services not traditionally commoditized in the past by allowing the services to be priced and delivered in a more uniform fashion. While access may be provided for any of a nearly limitless number of services provided by service providers, examples of commoditization of services may be applied to many areas including various yard and home services, such as: lawn mowing, lawn fertilizing, basic home repairs, painting, cleaning, gardening, small appliance repair, etc. A service provider can be any service provider, contractor, service contractor, service group, or service supply entity that provides a service to a customer.

This technology may allow a user to select a service or task (e.g., lawn mowing) to be purchased electronically, and a user interface on a client device can present choices to the customer that include task parameters and other details about the service. These service parameters can be used to provide efficient commodity-like pricing. The service parameters may include task details or variables that affect pricing and other factors for the task. In a lawn mowing example, parameters may be collected from a customer that include: lawn shape and size, length of grass, type of grass, physical location, quality of service provider desired, need for repeat service, etc. The pricing of the service or task may be a fixed price that is calculated using existing facts about the service and statistical data known about task prices in a geographical area, etc. With iterated services and sufficient service provider and customer feedback, the pricing can become more accurate over time such that each task may become more like a standard unit of work that is priced with increasing accuracy. The terms “service” and “task” are sometimes used interchangeably in this description.

Commoditized tasks purchased by a customer through this technology can be matched with one of a plurality of service providers who have schedule availability to perform the task. Customers may have the opportunity to select preferred service providers from a list of available service providers, but the selection of a service provider is optional. A customer may be encouraged to allow the service provider to be assigned automatically using a computing device, and the customer may be encouraged not to select a service provider through various pricing and other inducements. As the services become more commoditized, the service providers become more easily interchangeable. This can provide an experience similar to a customer's experience in a retail setting where the customer is more interested in the quality of the goods received than which individual made the goods being purchased.

Service providers can be matched to customers on the basis of a number of additional parameters identified by the service providers and these parameters may include: shortest distance to customer, higher schedule availability, matching skill level, quality level desired, and other parameters. The value provided to service providers may be increased by providing more customers, assigning customers situated closer together, automated pricing, back office accounting and management functions, and other ways that improve service provider efficiency and/or boost service provider revenues.

Using a commodity approach can simplify the service purchase process and can make buying services more analogous to buying tangible goods through a retail store. Detailed methods may be used to compute a fair market pricing for the service based on customer provided specifications about the service to be performed. The fair market pricing can allow a fixed price to be presented to the customer, at the point of sale, and allow the customer to complete a transaction immediately.

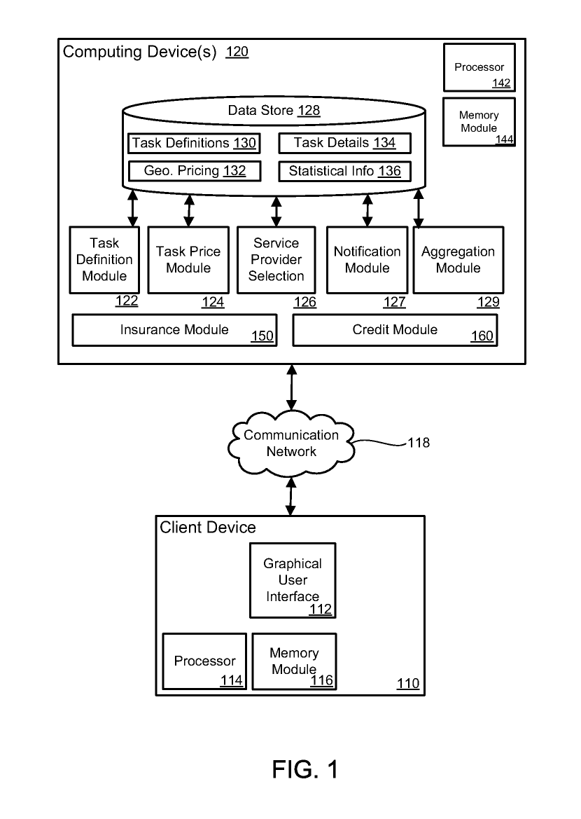

As illustrated in FIG. 1, a system can be used for delivering, pricing, assigning, managing and exchanging tasks. The system may include a client device 110 through which a user can access information related to tasks and customers over a communications network 118. The communications network can be a local area network (LAN), wide area network (WAN), or the internet. A graphical user interface 112 can be provided to the user using the client device 110 to access the task, customer, and related information located on a separate computing device 120. A client device 110 with a graphical user interface 112 may be used by either a service provider or a customer.

Parameters for a task that the customer desires to be performed can be received by the graphical user interface 112 of the client device 110. For example, the customer may type, speak, write, or select task parameters that the client device 110 can capture. Payment for the task selected by the customer may also be supplied via the graphical user interface. In one example, payment via a credit card or debit transaction is collected before the task is assigned to a service provider for performance. The client device may include a processor 114 and a memory module 116. A client device 110 may be a device such as, for example, a desktop computer, a laptop, a tablet, a mobile device, a television, a cell phone, a smart phone, a hand held messaging device, a set-top box, a gaming console, a personal data assistant, an electronic book reader, heads up display (HUD) glasses, or any device with a display suitable for presenting the graphical user interface 112.

The parameters for a task collected by the client device 110 can be sent to a computing device 120. The computing device 120 may be provided with modules for providing and managing tasks and customers. Additional related functions for communication, fixed pricing, service provider selection, task exchange, and task valuation can also be provided, as will be described later. The computing device 120 may be a single server, a distributed server environment, a server farm, or any computing device or group of computing devices that may service requests from other computing devices or programs. In addition, the computing device may include one or more processors 142 and memory modules 144.

The parameters that are requested from the customer can be collected and used by a task definition module 122. The task definition module 122 can also obtain a task definition for a task which describes task details to be performed for a customer. In addition, the task definition module 122 can access the task definitions 130 located in the data store 128, and the task definitions may include specific definitions of what procedures are going to be undertaken for a task. For example, the task definition can define a mowing job as: 1) cutting grass and 2) blowing loose grass off sidewalks. The task definition may also include a question template to send to customers to obtain the factual task parameter information that is desired to be captured from the customer about a task type. The customer's replies and specific factual data collected in response to the questions about tasks can be stored in the task details 134 data store. The data store 128 may refer to any device or combination of devices capable of storing, accessing, organizing, and/or retrieving data, which may include any combination and number of data servers, relational databases, object oriented databases, simple web storage systems, distributed storage systems, data storage devices, data warehouses, flat files, and data storage configuration in any centralized, distributed, or clustered environment. The storage system components of the data store may include storage systems such as a SAN (Storage Area Network), cloud storage network, volatile or non-volatile RAM, optical media, or hard-drive type media.

A fixed price for a task may be determined based on the parameters collected about the task. Statistical price data for tasks may also be used in calculating the fix price for a task. As mentioned earlier, the fixed price is the fee under which a service provider is expected to perform the task for the customer after the service provider has received the task assignment. In one example, the service provider may simply work on tasks automatically assigned to the vendor's schedule, or in another example, the service provider may choose to approve work assignments in advance of scheduling. A significant portion of the retail fixed price charged to the customer can be paid to the service provider and a smaller portion of the fixed price may be retained by the entity operating the technology described in this description. For example, the fixed price can be calculated using a task price module 124 to set a task price for the task based on the task details and statistical price data identified in the statistical information 136 data store.

The fixed price can be calculated, in part, using the task details 134 provided by the customer, as stored in the data store 128. These task details may include one or more of the following details: time since last service performed, square dimensions of project, current state or quality of project, desired state or quality of project, number of hours service may be performed, distance to be traveled, number of units to be transported, average amount of time similar jobs have historically consumed, average cost of parts similar jobs have historically consumed, number of levels or stories of a structure, number of rooms in a structure, square dimensions of a structure, the presence of exterior improvements such as a swimming pool, hot tub or basketball court, the desired start date, the desired completion date, whether a specific time or an approximate time is desired for performance of the service, the number of legal steps required by law, the grade or style of materials used, the frequency of recurrence, the depth or quantity of material to be moved or removed, the linear dimensions of project, etc.

Additional input parameters may also be obtained automatically from third parties. For example, a house lot size, square footage of the house, number of bedrooms and bathrooms, and related real property information can be obtained for a real estate information vendor. Similarly, mapping data and address correction data can be obtained from a mapping information vendor. Weather data can be obtained (e.g., for snow clearing predictions) including snow accumulation hourly actual measurements along with future predictions, temperature and humidity for estimating snow ablation from a weather information source.

Service provider feedback about customers and tasks can help refine task pricing. In some cases, there may be unexpected aspects of the tasks that occur with certain customers or certain types of tasks. For example, edging a customer's lawn may be more difficult the first time where the customer has a very overgrown lawn. Customer feedback about service providers (quality, timeliness, speed, etc.) may also be used to refine the method of matching service providers with tasks. In addition, customer feedback can also be used in refining the task pricing.

As discussed, a service provider may be selected from among the plurality of service providers to perform the task. The service provider selection can take place using the service provider selection module 126. Criteria for selecting a service provider may include using at least one of the following: a distance between the service provider and customer, time slots made available by the service provider, a skill level of service requested, previous performance feedback of the service provider from prior customers, quality tier of a service provider, etc. Other criteria or metrics about service providers may also be used in selecting a service provider, as desired.

The customer and the service provider can be notified of the service provider selection using the notification module 127. In one example, the notification module may prepare a web page or a web application page to be sent to the customer. Alternatively, a notification can be sent through the graphical user interface 112 on the client device 110 using an application on the client device 110. Other types of notifications may include: emails, instant messages, text messaging, or any other message type that can be received by the customer. Once the service provider has been selected, then the service provider can be scheduled to perform the task. More specifically, the task can be added to an available time slot on the service provider's calendar, and the customer can be notified of the scheduled task time. The notification module can also prepare other network pages, web pages, or web application pages to communicate other information to the client device 110.

In one configuration, the technology may allow just a limited number of service providers per market. A market may be a geographical market or a specific task type in a geographical area. Each service provider may be notified that as long as the service provider is willing to perform the work received by the service provider from the system, the service provider can continue to participate. This may encourage service providers to quickly sign up for markets the service provider services, so the service provider does not lose out on the possibility of new customers received through the technology. Additional service provider slots in a given market might be made available as customer demand for services in a given market begins to exceed service provider supply.

The system illustrated by FIG. 1 can also provide tools to a service provider for: managing the service provider's customers, managing the service provider's team members, monitoring jobs and schedules, managing finances, finding new customers and other service provider related functions.

Some existing services for referring a service provider to a customer take input from customers and pass the customer information along to the service provider in the form of a lead. The service providers can then bid on the task and the customer is able to select from multiple bids. Such approaches have the customer return to the website and make an additional decision as to which of the many service providers who have bid the customer would like to use. While a bidding system is useful for connecting a service provider to a customer, the overall bidding process is slow and cumbersome. Furthermore, existing services typically do not act as a payment broker to give the customer control over payment to the services provider based on quality of work performed.

### Task Valuation

Once tasks and services for customers exist within the technology environment, a value may be placed on the task and/or customer within the environment. The task may be valued based on a plurality of factors related to the service provided. One example valuation factor may be the fixed price of the task paid each time the task is performed for the customer. Since the one time price paid for completing a task is not the only measure of a task's value, other task value measures can be considered. Another factor may be the task frequency because a more frequently performed task is likely to increase a task's value as compared to a less frequently performed task. The task may also be valued based on the distance of the task from the service provider's home base or defined geographic area. A home base may be any defined location that the service provider considers to be a starting location from which labor, materials, and machines can be dispatched to perform a task. Where a customer is a comparatively long distance from the service provider's home base or geographic service area, then the value to the service provider may be lower. Customers closer to the service provider may be rated as a higher value to the service provider. In one example, this distance valuation may be performed using a distance weighting value assigned to the task or the customer.

Tasks may be valued based on a distance of a task from another task owned by a service provider or the distance of a task from every other existing task. For example, tasks that are located on a route already being serviced by a service provider may be more valuable to the specific service provider because they can be serviced by a service provider more easily. In contrast, tasks that are not near a route or geographic area being serviced by any service provider may be of lower value to service providers.

A further valuation method may be a customer value determined based on a group of fixed price tasks purchased by the customer and the frequency at which each task is being provided. Value can be assigned to individual tasks that have been purchased by the customer and the combination value of these task values can be aggregated. This aggregated value for multiple tasks can provide the total value of the customer within the system.

The task valuation may result in a credit valuation being associated with the task and/or customer. This credit valuation can be a private currency valuation, a government currency (e.g., dollars, pounds, etc.), or credits and can represent a value of the task or customer within the technology system. The number of credits associated with a task may take into account the items discussed earlier, including: the task price, task recurrence, distance from a service provider, and other factors, etc. For example, such credit valuations may be applied using a credit module 160 to set a credit value for the task based on the task price and task frequency. The credit module 160 may also set the credit value based in part on a distance of the task from the seller service provider (e.g., contractor) or the buyer service provider (e.g., contractor). The credit module 160 may set the credit value of a task based in part on additional attributes of the task such as: distance of the task from any service provider, a distance of the task from any nearest existing task or a distance of the task from a scheduled nearest task for a service provider. The credit valuations for a task may be recorded in a service provider's account within the system.

In an example, a first task can have a higher value as compared to a second task when the first task has a higher price per completion instance as compared to the second task and/or the first task is being performed more frequently. As an example, a large lawn may have a higher price ($100) due to the size of the lawn and the lawn may be mowed once a week. Whereas, a small lawn ($30) may be mowed just once a month. Thus, an example of relative value may be that the large lawn is worth 4000 credits as a task and the small lawn is worth 300 credits. In a related example, if the small lawn ($30) is being mowed each week then the value of the small lawn may be 1200 credits and if the large lawn is being mowed just once a month, then the value of the large lawn maybe 1000 credits (i.e., less than the small lawn).

In another example valuation, an individual task within the system can be assigned a credit value based directly on the task's fixed price. For example, a customer with a $50 task performed once a week may be worth 1 credit and a $50 task performed once a month may be worth 0.25 credits. In contrast, a $50 task performed just once may only be worth 1/50 of a credit or 0.02 credits or even less. The credit valuations may be normalized throughout the system on the average task value, mean task value, or another task value measure. Of course, such credits may be scaled by a factor of 10, a factor of 100 or another factor as desired. This valuation allows the technology to discriminate between one time customers, less frequent customers, and repeating customers. When distance is a factor in valuation, the credit price may be increased or decreased according to a percentage value or weighting that represents distance. For instance, if the mean customer distance for most service providers is 10 miles but a specific customer is only 7 miles away from a selected service provider, then the credit value for that customer may increase 30% or another percentage as selected by the system.

Another example of a credit valuation factor may include a weighting value applied to the task based a computed quality value of the customer. Customer quality can be determined using criteria like: how many times the customer historically has had their lawn mowed using the system (e.g., a high number may indicate a more stable customer and therefore the customer may be worth more in credits); how frequently the customer complains about services performed; how many different services the customer has ordered; a customer's credit score; etc.

### Insurance

Once tasks and customers have been valued, insurance policies or riders can be provided that serve to insure against one or more insurable risks associated with performance of the task. The system can be utilized to provide insurance, or ensure that adequate insurance is in place, or to bridge any gaps between existing insurance and actual events.

FIG. 1 illustrates that an aggregation module 127 that can be used to determine a number of tasks to be performed by service providers (e.g., uninsured service providers) during a pre-defined time period. An insurance module 150 can be provided to apply insurance policies or riders or daily prorated fees via the electronic exchange interface to ensure that any task provided by a service provider is covered by an insurance rider. The insurance rider can be carried by the managing entity controlling the insurance exchange module 150, and can be in place to cover all, or most, insurable risks associated with the provision of any task. The cost for the insurance rider or prorated daily fee can typically be borne by the service provider. This means that for an equivalently valued customer or task, a service provider will typically receive a smaller payment for providing the service than the service provider would otherwise receive, in order to cover the costs associated with the rider or prorated daily fee.

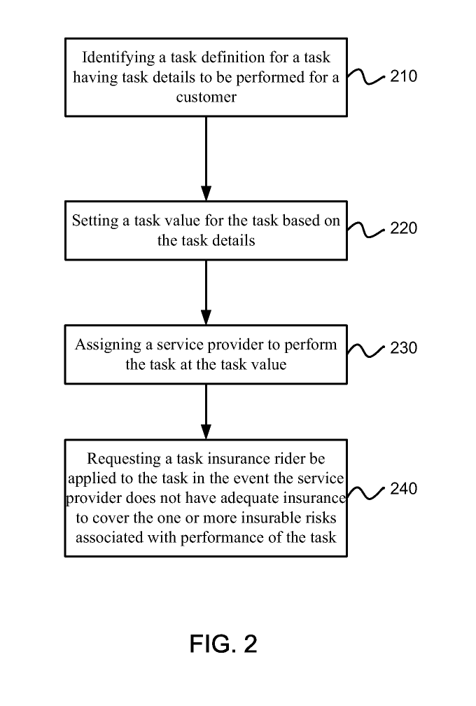

FIG. 2 illustrates one exemplary method by which an insurance rider can be associated with a particular task. In this example, it is the managing entity that is coordinating the majority of details relating to insuring the task at hand. At 210, a task definition can be obtained or identified for a task having task details to be performed for a customer. The task definition can include specific definitions of what procedures are going to be undertaken for a task. For example, the task definition can define a mowing job as: 1) cutting grass and 2) blowing loose grass off sidewalks. The task definition may also include a question template to send to customers to obtain the factual task parameter information that is desired to be captured from the customer about a task type. The customer's replies and specific factual data collected in response to the questions about tasks can be stored in the task details 134 data store. At 220, a task value can be set for the task based on the task details.

At 230, a service provider can be assigned to perform the task at the task value. Each of these actions can typically be performed by the various computing devices 120 of the system illustrated in FIG. 1.

At 240, it can be determined whether the service provider has adequate insurance to cover one or more insurable risks associated with performance of the task. This determination can be made initially by simply requesting the information from the service provider. However, this information may be verified later by an automated process or by routine audits performed by the managing entity or the insurance company providing the insurance. In the case where the information provided by the contractor is incorrect, the invention can provide various methods by which policies or riders can be applied to various tasks, and the costs associated therewith can be attributed to the service provider. In one example, the insurance company providing the coverage can audit all tasks performed over a given period (for example, over a one month period) and can charge for uninsured tasks in arrears. In this scenario, the insurance company assumes the risk of tasks performed during this conditional period of acceptance before they have had time to verify the need for, or extent of, insurance for any particular task.

The technology can also address the issue that arises when the contractor indicates that he or she doesn't have insurance and needs to obtain a rider. Afterward, it might be discovered (either by the service provider or by the insurance company) that he or she in fact was properly insured. In this case, the service provider might have paid for a rider when the rider was not necessary. If such is the case, the system can properly refund these types of overpayments at periodic reconciliation times.

At 240, a task insurance rider can be applied to the task in the event the service provider does not have adequate insurance to cover the one or more insurable risks associated with performance of the task.

The insurance policy or rider applied in this manner can cover one or more of the following aspects associated with performance of the task: proper performance of the task; quality of the performance of the task; liability of the service provider (e.g., individual, company or group performing the task); risk to property, life or limb, etc.; liability of the customer (e.g., the individual, company or group that requested the task), etc.

The type of insurance policy or rider requested can be one of a myriad of types of insurance. Examples include, without limitation, general liability insurance, workers' compensation insurance, occupational accident insurance, surety or performance bonding, and miscellaneous insurance typically carried by service providers (such as, for example, commercial vehicle insurance).

The cost of the task insurance rider can be included in the task value in a number of manners. One exemplary manner by which such a cost can be determined is outlined on Page 7 of Exhibit A. Once the cost is determined, it can be charged to the service provider in a variety of ways. For example, the cost of the task insurance can be subtracted from the task value when the task insurance rider is applied. Alternatively, the cost of the rider can be added to the task value. The insurance value of an insurance rider may be adjusted up or down based on a geographical location where the task is performed. For example, the insurance value of an insurance rider may be lower in Louisiana as compared to New York City, N.Y. Thus, the service provider may be charged less in less expensive geographical locations and vice-versa.

A plurality of task insurance riders can be aggregated over a period of time and an insurance provider or carrier can be paid for task insurance coverage based on the aggregated task insurance riders during this period of time. Gap insurance coverage can be utilized for the plurality of task insurance riders, to cover, for example, any non-insured risks associated with performance of the task. If a system has been operational for a sufficient period of time, a list or group of preapproved task insurance riders can be generated, and a suitable rider can be selected from this list or group to be applied to a task.

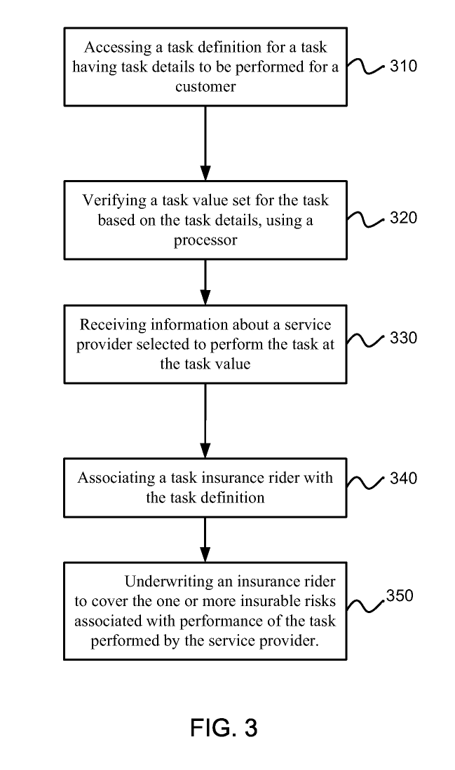

FIG. 3 illustrates another manner in which an insurance policy or rider can be applied to a task in accordance with another embodiment of the invention. In this example, it is the insurance provider that is coordinating the majority of details relating to insuring the task at hand. At 310, a task definition can be assessed for a task having task details that is to be performed for a customer. Typically, this task detail information can be provided to the insurance provider by the managing entity. The information can be provided in response to a query from the insurance provider, or the insurance provider may have direct access to the insurance module 150 (FIG. 1). Alternatively, the insurance module can be a portion of the insurance providers existing infrastructure and can be in communication with the managing entity's infrastructure.

At 320, the task value set for the task can be verified, based generally on the task details and computed using one or more of the processors already discussed. At 330, information about the service provider being evaluated to perform the task can be received. Information relating to the service provider can include, without limitation: a geographical location of the service provider and customer, time slots indicated as available by the service provider, a skill level of the service provider, previous performance feedback about the service provider, quality tier of a service provider, etc. Other criteria or metrics about service providers may also be used, as desired

At 340, a task insurance rider can be associated with the task definition. At 350, the insurance provider can underwrite an insurance rider to cover the one or more insurable risks associated with performance of the task to be performed (or already performed) by the service provider.

In one aspect, the technology can provide various insurances to service providers that have traditionally been primarily available to the service providers only under conventional “group” insurance plans, such as employee benefits packages, or if the service provider purchased an insurance policy directly. Examples of such insurance include health insurance, life insurance, and the like. Typically, an individual service provider only became eligible for such coverage when he or she worked full time for select employers. Under the present technology, however, these types of group insurance policies can be made available to service providers at defined levels of participation within the system. For example, a service provider may become eligible for some level of health insurance coverage after completing his or her fifth task within the system. At lower levels of participation, the service provider may have to pay a higher percentage of the premium for this insurance, with his or her contribution toward the premium reducing with the number of tasks he or she completes within the system. For example, after completing twenty tasks within the system, the service provider may pay only a small fraction of the cost of the insurance, or none of the cost.

In one aspect, the fraction of the premium borne by the service provider can be a direct correlation with the number of hours worked by the service provider within the system. That is, a service provider who works 50% of the week (e.g., 20 hours) within the system could be responsible for 50% of the premium for health insurance. A service provider who works fully within the system (e.g., 40+ hours per week) might pay very little, or none, of the premium for health insurance.

This aspect of the technology can be advantageous in a number of ways. First, it can motivate service providers to participate more fully within the system (e.g., to provide more and more services, or more and more types of services). Secondly, this aspect provides insurance policies that are tied to task-specific activities, allowing the value and availability of the insurance to be tied to the smaller increments of specific tasks (or larger increments of aggregated tasks), consistent with the specific insurance types addressed above. Also, in the particular case of health insurance, this insurance policy may allow service providers to benefit from the cost reductions that may be made available to the managing entity when negotiating insurance premiums based on a large pool of clients (e.g., a large number of service providers). Even if the service providers were charged 100% of the premium allocated to their coverage, it is likely that this cost will be significantly less than if the service provider were to purchase the health insurance directly.

In addition to the examples provided above relating to providing insurance policies or riders covering the risks associated with specific tasks, the present invention also contemplates providing insurance to service providers based upon a certain level of aggregate work performed by the specific service provider. This can include past performance by the service provider, and/or an estimate of future work that will be performed by that service provider. This computation can allow the application of various insurance policies or riders that are not as amenable to task-specific application as are other types of insurance. Examples of such broader coverage include, without limitation, health insurance, life insurance, death and dismemberment insurance, and other types of insurance that have been difficult to apply in the past (due to the benefit necessitating greater than a certain number of tasks to be worth the insurance company providing a given relevant insurance to the contractor/service provider). In other words, there may be types of insurance that cannot readily be provided at the task level, but instead require that the managing entity be able to show some significant annual percentage of a Full-Time Equivalence being worked by a given service provider for said service provider to be eligible to participate in this insurance pool.

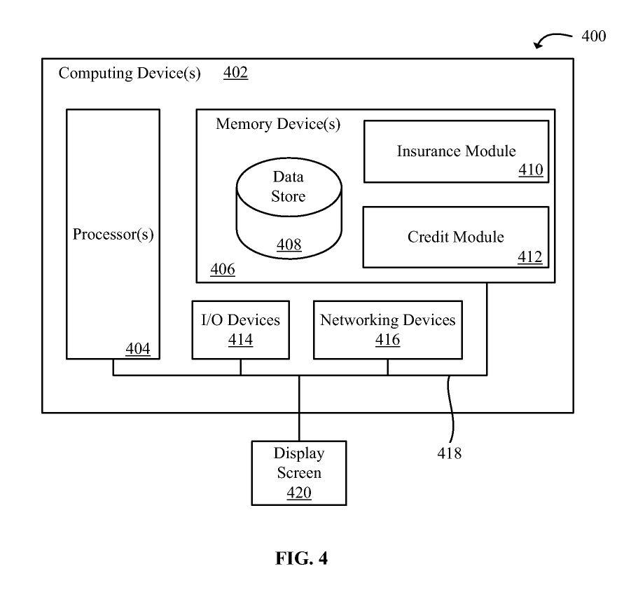

FIG. 4 is block diagram 400 illustrating an example of a computing device 402 that may be used for discovering content. In particular, the computing device 402 is illustrates a high level example of a device on which modules of the disclosed technology may be executed. The computing device 402 may include one or more processors 404 that are in communication with memory devices 406. The computing device 402 may include a local communication interface 418 for the components in the computing device. For example, the local communication interface may be a local data bus and/or any related address or control busses as may be desired.

The memory device 406 may contain modules that are executable by the processor(s) 404 and data for the modules. Located in the memory device 406 are modules executable by the processor. For example, an insurance module 410, a scheduling module 412 and other modules may be located in the memory device 406. The modules may execute the functions described earlier. A data store 408 may also be located in the memory device 406 for storing data related to the modules and other applications along with an operating system that is executable by the processor(s) 404.

Other applications may also be stored in the memory device 406 and may be executable by the processor(s) 404. Components or modules discussed in this description that may be implemented in the form of software using high programming level languages that are compiled, interpreted or executed using a hybrid of the methods.

The computing device may also have access to I/O (input/output) devices 414 that are usable by the computing devices. An example of an I/O device is a display screen 420 that is available to display output from the computing devices. Other known I/O devices may be used with the computing device as desired. Networking devices 416 and similar communication devices may be included in the computing device. The networking devices 416 may be wired or wireless networking devices that connect to the internet, a LAN, WAN, or other computing network.

The components or modules that are shown as being stored in the memory device 406 may be executed by the processor(s) 404. The term “executable” may mean a program file that is in a form that may be executed by a processor 404. For example, a program in a higher level language may be compiled into machine code in a format that may be loaded into a random access portion of the memory device 406 and executed by the processor 404, or source code may be loaded by another executable program and interpreted to generate instructions in a random access portion of the memory to be executed by a processor. The executable program may be stored in any portion or component of the memory device 406. For example, the memory device 406 may be random access memory (RAM), read only memory (ROM), flash memory, a solid state drive, memory card, a hard drive, optical disk, floppy disk, magnetic tape, or any other memory components.

The processor 404 may represent multiple processors and the memory 406 may represent multiple memory units that operate in parallel to the processing circuits. This may provide parallel processing channels for the processes and data in the system. The local interface 418 may be used as a network to facilitate communication between any of the multiple processors and multiple memories. The local interface 418 may use additional systems designed for coordinating communication such as load balancing, bulk data transfer and similar systems.

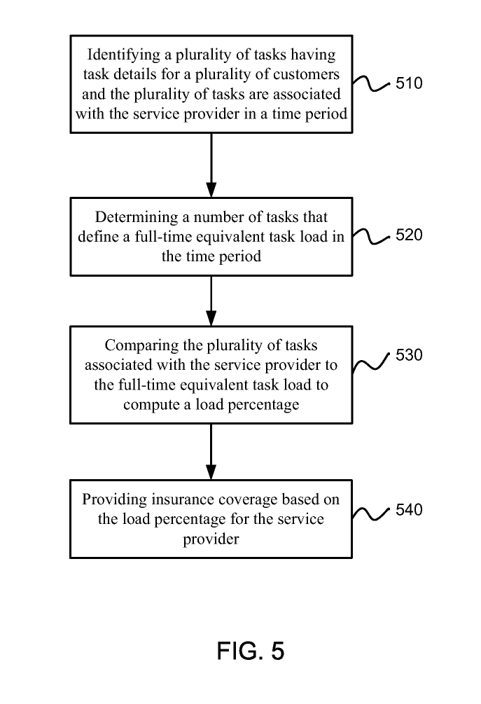

FIG. 5 illustrates an example method of providing insurance for a service provider. The method may include the operation of identifying a plurality of tasks having task details for a plurality of customers. The plurality of tasks may be associated with the service provider in a time period, as in block 510. A number of tasks that define a full-time equivalent task load in the time period can also be defined, as in block 520. This number of tasks may have been defined in advance or at the time of the determination. For example, it may be determined that 30 tasks is the equivalent of a full-time task load. Alternatively, the number of tasks that need to define a full-time task load may be based on a number of dollars that are to be earned by a service provide in a specific period to determine that a full-time equivalent task load is reached. A time period may be: a week, a month, a quarter, a semi-annual period, or a year. In one specific example, the full-time equivalent task load may be defined as a minimum number of tasks to be completed in a 40-hour work week or some other number of anticipated number of hours in a work week. As another example, 160 hours can be used as a full-time benchmark for a month.

The plurality of tasks associated with the service provider can be compared to the full-time equivalent task load to compute a load percentage, as in block 530. For example, insurance coverage can be provided based on the load percentage for the service provider. If the service provider is performing 50% of an expected full-time work load in performing assigned tasks, then the service provide may be eligible for 50% cover in available insurance. Insurance coverage can then be provided based on the load percentage for the service provider, as in block 540. Examples of the insurance coverage may be health care insurance, worker's compensation insurance, life insurance, disability insurance or other types of insurance.

In one configuration, the method can include providing the insurance coverage when a minimum load percentage is achieved by the service provider. If the service provider reaches a minimum 10% work load using the task assignment technology, then the service provider may be entitled to receive 10% of the benefits of a given insurance. Thus, a service provider who is providing approximately 10% of their work week to assigned task may be available for 10% of a specific type of health care coverage in a time period. If a service provider does not reach the threshold, then no insurance coverage may be provided.

Some of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in software for execution by various types of processors. An identified module of executable code may, for instance, comprise one or more blocks of computer instructions, which may be organized as an object, procedure, or function. Nevertheless, the executables of an identified module need not be physically located together, but may comprise disparate instructions stored in different locations which comprise the module and achieve the stated purpose for the module when joined logically together.

Indeed, a module of executable code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices. The modules may be passive or active, including agents operable to perform desired functions.

The technology described herein can also be stored on a computer readable storage medium that includes volatile and non-volatile, removable and non-removable media implemented with any technology for the storage of information such as computer readable instructions, data structures, program modules, or other data. Computer readable storage media include, but is not limited to, RAM, ROM, EEPROM, flash memory or other memory technology, CD-ROM, digital versatile disks (DVD) or other optical storage, magnetic cassettes, magnetic tapes, magnetic disk storage or other magnetic storage devices, or any other computer storage medium which can be used to store the desired information and described technology.

The devices described herein may also contain communication connections or networking apparatus and networking connections that allow the devices to communicate with other devices. Communication connections are an example of communication media. Communication media typically embodies computer readable instructions, data structures, program modules and other data in a modulated data signal such as a carrier wave or other transport mechanism and includes any information delivery media. A “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared, and other wireless media. The term computer readable media as used herein includes communication media.

Furthermore, the described features, structures, or characteristics may be combined in any suitable manner in one or more examples. In the preceding description, numerous specific details were provided, such as examples of various configurations to provide a thorough understanding of examples of the described technology. One skilled in the relevant art will recognize, however, that the technology can be practiced without one or more of the specific details, or with other methods, components, devices, etc. In other instances, well-known structures or operations are not shown or described in detail to avoid obscuring aspects of the technology.

Although the subject matter has been described in language specific to structural features and/or operations, it is to be understood that the subject matter defined in the appended claims is not necessarily limited to the specific features and operations described above. Rather, the specific features and acts described above are disclosed as example forms of implementing the claims. Numerous modifications and alternative arrangements can be devised without departing from the spirit and scope of the described technology.

1. A method for providing insurance for tasks, comprising:
identifying a task definition for a task to be performed for a customer, the task having task details associated therewith;
setting a task value for the task based on the task details, using a processor;
assigning a service provider to perform the task at the task value, using the processor;
determining whether the service provider has adequate insurance to cover one or more insurable risks associated with performance of the task; and
requesting a task insurance rider be applied to the task in the event the service provider does not have adequate insurance to cover the one or more insurable risks associated with performance of the task.

2. The method of claim 1, further comprising including a cost of the task insurance rider in the task value.

3. The method of claim 1, further comprising subtracting a cost of the task insurance rider from the task value when a task insurance rider is applied.

4. The method of claim 3, further comprising adding the cost of the task insurance rider to the task value.

5. The method of claim 1, further comprising aggregating one or more task insurance riders over a period and paying an insurance carrier for task insurance coverage based on the aggregated task insurance riders during the period.

6. The method of claim 5, further comprising using gap coverage from the insurance carrier for the one or more task insurance riders.

7. The method of claim 6, wherein the gap coverage covers any non-insured risks associated with performance of the task after the service provider represents the existence of insurance coverage.

8. The method of claim 6, wherein the gap coverage covers any non-insured risks associated with performance of the task.

9. The method of claim 1, further comprising setting a task value by setting a credit value or a money value for the task.

10. The method of claim 1, further comprising selecting the task insurance rider from a plurality of preapproved task insurance riders.

11. A method for providing insurance for one or more tasks, comprising:
accessing a task definition for a task having task details to be performed for a customer;
verifying a task value set for the task based on the task details, using a processor;
receiving information about a service provider selected to perform the task at the task value, using the processor;
associating a task insurance rider with the task definition; and
underwriting an insurance rider to cover the one or more insurable risks associated with performance of the task performed by the service provider.

12. The method of claim 11, further comprising estimating a number of tasks to be performed by uninsured service providers during a pre-defined time period.

13. The method of claim 12, further comprising underwriting the number of tasks to be performed during the pre-defined period of time.

14. The method of claim 11, further comprising:
determining whether the service provider has existing insurance to cover performance of the task; and
applying a task insurance rider to the task in the case the service provider does not have existing insurance to cover performance of the task.

15. The method as in claim 11, further comprising adjusting a value of an insurance rider based on a geographical location where the task is performed.

16. A method for insuring tasks, comprising:
identifying a task definition for a task having task details to be performed for a customer by a service provider;
setting a task price for the task based on the task details and statistical price data, using a processor;
setting a credit value for the task based on a task valuation;
determining whether the service provider has existing insurance to cover performance of the task; and
providing a task insurance rider for the task at an insurance value based on the credit value of the task, in the case the service provider does not have adequate insurance to cover one or more insurable risks associated with performance of the task.

17. The method of claim 15, wherein setting the credit value further comprises setting the credit value for the task based on a task valuation that uses the task price and task frequency.

18. The method of claim 15, further comprising setting the credit value for the task based on a task valuation that uses labor time, customer profitability, or task distance.

19. The method of claim 15, further comprising defining a task definition using a task template defining detailed task responsibilities.

20. The method of claim 16 further comprising adjusting the insurance value of an insurance rider based on a geographical location where the task is performed.

21. A system for applying task insurance to tasks, comprising:
a task definition module to identify a task definition for tasks having task details to be performed for a customer;
a task price module to set a task price for the tasks based on the task details and statistical price data;
an aggregation module to determine a number of tasks to be performed by service providers during a pre-defined time period; and
a task insurance module to provide a task insurance rider for a number of tasks without adequate insurance to cover one or more insurable risks associated with performance of the task.

22. The system of claim 19, further comprising a credit module to set the credit value based in part on a distance of the task from the service provider or the customer.

23. The system or claim 19, wherein the pre-determined time period is selected from the group consisting of: a day, a week, a month, a quarter, a semi-annual period, or a year.

24. A method of providing insurance for a service provider, comprising:
identifying a plurality of tasks having task details for a plurality of customers and the plurality of tasks are associated with the service provider in a time period;
determining a number of tasks that define a full-time equivalent task load in the time period;
comparing the plurality of tasks associated with the service provider to the full- time equivalent task load to compute a load percentage; and
providing insurance coverage based on the load percentage for the service provider.

25. The method as in claim 24, further comprising providing insurance coverage that is health care insurance, worker's compensation insurance, life insurance or disability insurance.

26. The method as in claim 24, wherein the full-time equivalent task load is defined as a minimum number of tasks to be completed in a 40-hour work week.

27. The method as in claim 24, further comprising providing the insurance coverage when a minimum load percentage is achieved by the service provider.

28. The method as in claim 24, wherein the time period is selected from the group consisting of: a week, a month, a quarter, a semi-annual period, or a year.

29. The method as in claim 24, wherein providing insurance coverage based on the load percentage for the service provider further comprises providing the insurance coverage in ratio to the load percentage.
